(19) United States
(12) Patent Application Publication
(10) Pub. No.: US 2004/0172873 A1
(43) Pub. Date: Sep. 9, 2004

(54) Fishing line straightening device and fishing line straightening method

(76) Inventor: Yoshimune Takahashi, Osaka (JP)

Correspondence Address: MOORE & VAN ALLEN, PLLC, 2200 W MAIN STREET, SUITE 800, DURHAM, NC, 27705, US

(21) Appl. No.: 10/248,997

(22) Filed: Mar. 7, 2003

(51) Int. Cl. A01K 1/00

(52) U.S. Cl. 43/4

(57) ABSTRACT

A fishing line straightening device is provided with, as its main body, a worktable having an air-permeable structure, and a surface covered with a cloth member such as felt. On the surface of the worktable, disk-shaped line pressing members for fixing a fishing line on the surface of the worktable are arranged at a prescribed interval by wing nuts or the like. The fishing line is sandwiched between the cloth member on the surface of the worktable and the line pressing members so that the fishing line is not loosened, and the fishing line between the line pressing members is subjected to heat treatment using a heated iron member, while blowing steam onto the fishing line.

### BACKGROUND OF INVENTION

### FIELD OF THE INVENTION

The present invention relates to a device and a method for straightening a fishing line and, more particularly, to those for straightening curl of the fishing line by steam-heating the same.

In recent years, most of the commercially available fishing lines are made of vinyl (chemically synthesized monofilament yarns), and they are packed being wound on cylindrical bobbins or being hauled into circular loops. Accordingly, such commercially available fishing lines are curled.

The curl of fishing lines greatly affects fish catches, and has become a serious problem for fishing lovers and those involved in the fishing industry. For example, fish are beware of curled fishing lines and do not come close to the fishing lines. When curled fishing lines are used as leaders, a feel of hooking a fish or a timing of a float sinking is delayed. Therefore, it is an important challenge for fishermen such as those engaged in fishery or fishing lovers to remove the curl of fishing lines. A device for straightening fishing lines has already been invented. FIGS. 9(a) and 9(b) illustrate a fishing line straightening device disclosed in Japanese Published Patent Application No. Hei.8-70744. As shown in FIGS. 9(a) and 9(b), this fishing line straightening device is constructed by a vertically-long rectangular-parallelepiped main body 110 which houses a heater (not shown) and a power source (not shown) such as a dry battery, and a flat plate 114 one end of which is rotatably attached to the upper surface of the main body 110. A convex part 118 is formed in a portion of the flat plate 114 which is opposed to the upper surface of the main body 110, and a concave part 116 capable of receiving the convex part 118 is formed on the upper surface of the main body 110. A switch button 124 for the heater is arranged on a side of the main body 110. In this main body 110, a current is applied to the heater by the switch button 124 to heat the concave part 116.

Next, a brief description will be given of a method for straightening a fishing line by employing the above-described fishing line straightening device. A portion of a fishing line 119 is placed in the concave part 116 on the upper surface of the main body 110, and the flat plate 114 is pressed against the upper surface of the main body 110 so that the fishing line 119 is sandwiched by the convex part 118 and the concave part 116. In this state, the switch button 124 placed on the side of the main body 110 is operated to heat the concave part 116 on the upper surface of the main body 110, and the head of the fishing line 119 that is sandwiched by the convex part 118 and the concave part 116 is pulled with hand in the direction shown by the arrow. Thereby, the fishing line 119 is sequentially heated from its head in the state where a prescribed tensile force acts, and the curl of the fishing line is removed.

However, since the conventional fishing line straightening device removes the curl by heating the fishing line with the simple heater, it is difficult to heat the fishing line at an optimal temperature. When the heating temperature is low, the curl of the fishing line cannot be removed completely. When the heating temperature is high, the fishing line is damaged and its strength is reduced and, in the worst case, the fishing line is melted to be cut.

Further, since the fishing line is pulled with hand to pass it through the concave part 116 as a heating part on the upper surface of the main body 110, it is difficult to heat the fishing line uniformly.

### SUMMARY OF INVENTION

The present invention is made to solve the above-described problems and has for its object to provide a device and a method for straightening fishing lines, which are able to effectively remove curls of fishing lines by heating the fishing lines uniformly at an optimal temperature.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided a fishing line straightening device comprising a fishing line fixing table for fixing a fishing line, wherein the fishing line fixing table has plural fishing line fixing members arranged in at least two positions on its surface, for fixing at least two portions of the fishing line so that the fishing line is stretched straight on the fixing table, and the fishing line fixing table serves as a worktable when the fishing line fixed on the surface of the fishing line fixing table is subjected to a process of pressing the fishing line using a heated iron member while blowing stream onto the fishing line. Therefore, the fishing line is uniformly heated without being damaged. Further, in contrast to the conventional lighter-type straightening device that heats the fishing line locally, the fishing line straightening device according to the present invention can heat the fishing line extensively, whereby curl of the fishing line can be easily and efficiently removed.

According to a second aspect of the present invention, the fishing line straightening device of the first aspect includes a first bobbin fitting part for rotatably supporting a fishing line bobbin on which the fishing line before being subjected to the pressing process using the iron member is wound, and a second bobbin fitting part for rotatably supporting a winding bobbin for winding the fishing line after being subjected to the pressing process using the iron member, said first and second bobbin fitting parts being placed in the vicinity of the fishing line fixing members. Therefore, the process of removing curl of the fishing line can be performed with high efficiency.

According to a third aspect of the present invention, in the fishing line straightening device of the first aspect, the fishing line fixing table has a cloth member covering the surface thereof, and the plural fishing line fixing members are fixed on the cloth member. Therefore, uniform heat treatment can be carried out through the cloth member when performing the process of blowing steam onto the fishing line and heating the fishing line using the iron member.

According to a fourth aspect of the present invention, there is provided a fishing line straightening device comprising a fishing line fixing table for fixing a fishing line, wherein the fishing line fixing table has fishing line fixing members on its surface, for fixing two portions of the fishing line having a prescribed length on the surface of the fixing table, and plural pulley members arranged in at least two positions on the surface of the fixing table, for winding and holding the fishing line at plural points so that the fishing line fixed between the fishing line fixing members is stretched straight, and the fishing line fixing table serves as a worktable when the fishing line fixed on the surface of the fishing line fixing table is subjected to a process of pressing the fishing line using a heated iron member while blowing stream onto the fishing line. Therefore, the fishing line is uniformly heated without being damaged. Further, in contrast to the conventional lighter-type straightening device that heats the fishing line locally, the fishing line straightening device according to the present invention can heat the fishing line extensively, whereby curl of the fishing line can be easily and efficiently removed.

According to a fifth aspect of the present invention, there is provided a fishing line straightening method employing a fishing line fixing table for fixing a fishing line, and the method comprises the steps of: fixing the fishing line by fishing line fixing members arranged in at least two positions on the fishing line fixing table having a flat surface so that the fishing line is stretched straight on a cloth member on the surface of the fixing table, and blowing steam onto the fishing line fixed on the cloth member on the surface of the fishing line fixing table and, simultaneously, pressing the fishing line using a heated iron member. Therefore, the fishing line is uniformly heated without being damaged. Further, in contrast to the conventional lighter-type straightening device that heats the fishing line locally, the fishing line straightening device according to the present invention can heat the fishing line extensively, whereby curl of the fishing line can be easily and efficiently removed.

According to a sixth aspect of the present invention, there is provided a fishing line straightening method employing a fishing line fixing table for fixing a fishing line, and the method comprises the steps of: fixing the fishing line having a prescribed length by fishing line fixing members arranged in two positions on the fishing line fixing table having a flat surface, and winding and holding the fixed fishing line by pulley members arranged in at least two positions on the fixing table so that the fishing line is stretched straight on the fishing line fixing table, and blowing steam onto the fishing line fixed on the surface of the fishing line fixing table and, simultaneously, pressing the fishing line using a heated iron member. Therefore, the fishing line is uniformly heated without being damaged. Further, in contrast to the conventional method using the lighter-type straightening device that heats the fishing line locally, the fishing line straightening device according to the present invention can heat the fishing line extensively, whereby curl of the fishing line can be easily and efficiently removed.

According to a seventh aspect of the present invention, in the fishing line straightening device of the first aspect, the fishing line fixing members are provided with means for moving the fixing members in the direction along which the fishing line is fixed and stretched as well as in the direction along which the tension of the stretched fishing line is released. Therefore, the fishing line can be easily stretched. Further, the fishing line which has been subjected to heat treatment can be easily detached from the fishing line straightening device, whereby working efficiency is improved.

### BRIEF DESCRIPTION OF DRAWINGS

FIGS. 1(a) and 1(b) are a perspective view and a side view of a fishing line straightening device according to a first embodiment of the present invention, respectively.

FIG. 2 is an enlarged view of a part in the vicinity of a line pressing member of the fishing line straightening device according to the first embodiment.

FIG. 3 is a diagram for explaining a state of steam heating of the fishing line straightening device according to the first embodiment.

FIG. 4 is a diagram for explaining a process using the fishing line straightening device according to the first embodiment.

FIGS. 5(a) and 5(b) are a plane view and a side view of a fishing line straightening device according to a second embodiment of the present invention, respectively.

FIG. 6 is a plane view of a fishing line straightening device according to a third embodiment of the present invention.

FIGS. 7(a) and 7(b) are a plane view and a partial cross-sectional view of a fishing line straightening device according to a fourth embodiment of the present invention, respectively.

FIG. 8 is a diagram showing a modification of the fishing line straightening device according to the fourth embodiment.

FIGS. 9(a) and 9(b) are diagrams illustrating the construction of the conventional fishing line straightening device.

FIG. 10 is a diagram illustrating the construction of a fishing line straightening device according to a fifth embodiment of the present invention, with a central focus on a line pressing member thereof.

### DETAILED DESCRIPTION

[Embodiment 1]

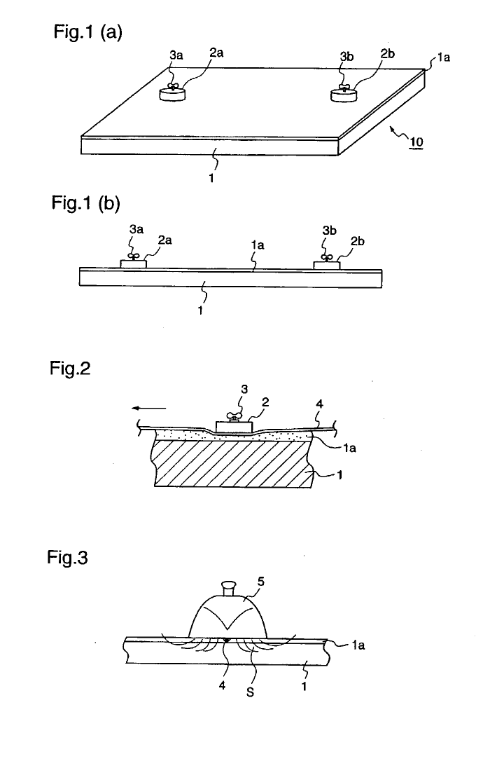

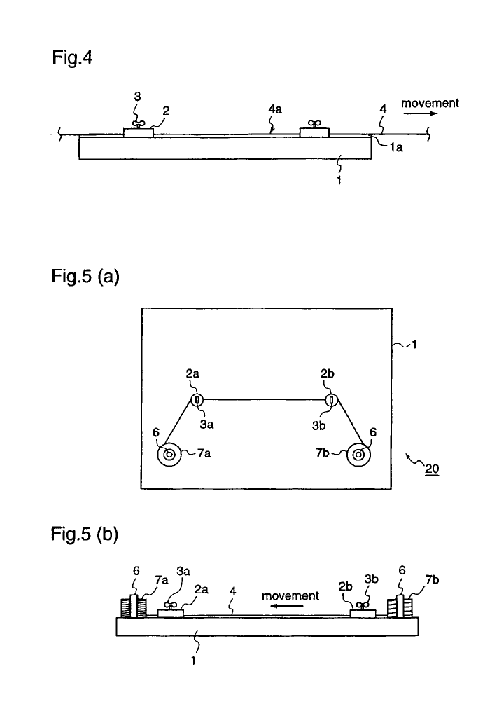

Hereinafter, a fishing line straightening device according to a first embodiment of the present invention will be described with reference to FIGS. 1(a) and 1(b). FIG. 1(a) is a perspective view of a fishing line straightening device 10 according to the first embodiment of the present invention, and FIG. 1(b) is a side view thereof.

The fishing line straightening device 10 of this first embodiment has, as its main body, a worktable 1 with an air-permeable structure. A cloth member 1a such as felt is attached to the surface of the worktable 1. It is preferable that the color of this cloth member 1a on the surface of the worktable 1 is other than white-base colors, so that a fishing line can be easily distinguished.

Further, disk-shaped line pressing members 2a and 2b for fixing the fishing line on the surface of the worktable 1 are attached to the surface of the worktable 1 by wing nuts or the like at a prescribed interval. As a material of the line pressing members 2a and 2b, there is a metal, synthetic resin, hard rubber, or the like.

Next, a description will be given of how to use the fishing line straightening device. Initially, a required length of fishing line which is packed being wound on a cylindrical bobbin or the like is let out, and its end portion is sandwiched and fixed between the line pressing member 2a and the cloth member 1a on the surface of the worktable 1, while the let-out fishing line on the bobbin side is sandwiched and fixed between the line pressing member 2b and the cloth member 1a on the surface of the worktable 1, as shown in FIG. 2. At this time, the fastening forces of the respective line pressing members 2a and 2b by the wing nuts 3a and 3b are adjusted according to the width of the fishing line or the like to such an extent that a slight tensile force is applied to the fishing line between the line pressing members 2a and 2b to prevent the fishing line from being loosened.

Then, a heated iron member is pressed against the fishing line between the line pressing members 2a and 2b to heat the same, while blowing steam to the fishing line. Here, a general home-use iron can be used as the iron member. When a steam iron is used, steam blowing and heating can be performed with high workability.

A chemically synthesized monofilament made of a material such as nylon, polyester, polyamide or phlorocarbon, which is employed as fishing lines in recent years, moderately softens when being heated. Therefore, the temperature of the steam iron is set to the medium level (about 160° C.), and the iron is moved from the line pressing member 2a side to the line pressing member 2b side along the fishing line 4 in the state where the fishing line 4 which is fixed on the worktable 1 is pressed against the worktable 1 with the iron as shown in FIG. 3. At this time, the portion of the fishing line 4 that is pressed by the steam iron 5 is heated for a predetermined period of time, being covered with the heated surface of the steam iron 5 and the cloth member 1a containing hot steam S. Thereby, the heat-treated portion of the fishing line 4 is once softened, and the curl of this portion is removed.

Further, the steam S from the steam iron 5 prevents an extreme increase in the temperature of the portion of the fishing line 4 that is heated by the steam iron 5, whereby the fishing line 4 is prevented from being damaged by overheat. Furthermore, the steam S smoothes sliding of the bottom surface of the iron 5 on the fishing line 4.

When the heat treatment onto the portion 4a of the fishing line 4 between the line pressing members 2a and 2b is finished, the fishing line 4 is moved so that a heat treatment target portion of the fishing line 4 is positioned between the line pressing members 2a and 2b, and the same heat treatment as described above is performed to the portion 4a of the fishing line 4 between the line pressing members 2a and 2b.

As described above, in the fishing line straightening device 10 according to the first embodiment, the worktable 1 having an air-permeable structure, on which the cloth member 1a such as felt is attached, is provided as a main body, and the disk-shaped line pressing members 2a and 2b for fixing the fishing line on the surface of the worktable 1 are attached to the surface of the worktable 1 by wing nuts or the like at a prescribed interval. The fishing line 4 is sandwiched between the cloth member 1a on the surface of the worktable 1 and the line pressing members 2a and 2b so that the fishing line is not loosened, and heat treatment is performed on the fishing line 4 between the line pressing members 2a and 2b using the heated iron member, while blowing the steam S to the fishing line. Therefore, the curl of the fishing line 4 can be effectively removed without damaging the fishing line 4 by heating.

Further, since the portion of the fishing line 4 between the line pressing members 2a and 2b is sequentially moved, heat treatment to the fishing line 4 can be extensively performed with high workability. Furthermore, since the steam iron 5 is used as an iron member, blowing of the steam S and heating can be performed with high workability.

[Embodiment 2]

Next, a fishing line straightening device according to a second embodiment of the present invention will be described. FIGS. 5(a) and 5(b) are a plane view and a side view of a fishing line straightening device 20 according to the second embodiment, respectively. In these figures, the same reference numerals as those shown in FIG. 1 denote the same or corresponding parts.

In the fishing line straightening device 20 of the second embodiment, bobbin fitting pins 6 to which a bobbin 7a for winding a fishing line 4 and a bobbin 7b for delivering the fishing line 4 are fitted are placed in the vicinity of the line pressing members 2a and 2b of the fishing line straightening device 10 according to the first embodiment, respectively.

Next, a description will be given of how to use the fishing line straightening device. A commercially available bobbin on which the fishing line 4 is wound (the fishing line delivering bobbin 7b) is fitted to one of the bobbin fitting pins 6, and the winding bobbin 7a for winding the heat-treated fishing line 4 is fitted to the other bobbin fitting pin 6.

Then, the fishing line 4 is let out from the delivering bobbin 7b, and an end of the fishing line 4 is wound on the winding bobbin 7a as shown in FIG. 5(a). Further, the fishing line 4 between the bobbins 7a and 7b is sandwiched and fixed between the two line pressing members 2a, 2b and the cloth member on the surface of the worktable 1.

Thereafter, in like manner as described for the first embodiment, the fishing line 4 which is fixed on the cloth member on the surface of the worktable 1 by the two line pressing members 2a and 2b is heated using a heated iron member such as a home-use iron, while blowing steam onto the fishing line 4. When the heat treatment onto the fishing line 4 between the line pressing members 2a and 2b is finished, the fishing line 4 is moved in the direction of the arrow, and the heat-treated portion of the fishing line 4 is wound on the winding bobbin 7a.

As described above, in the fishing line straightening device 20 according to the second embodiment, the bobbin fitting pins 6 to which the bobbin 7a for winding the fishing line 4 and the bobbin 7b for delivering the fishing line 4 are fitted, are provided in the vicinity of the line pressing members 2a and 2b, respectively. Thereby, the fishing line 4 is delivered from the delivering bobbin 7 that is fitted to one of the bobbin fitting pins 6, and the heat-treated fishing line is wound on the winding bobbin 7a that is fitted to the other bobbin fitting pin 6, whereby the curl of the fishing line 4, which extends over a wide area, can be removed effectively.

[Embodiment 3]

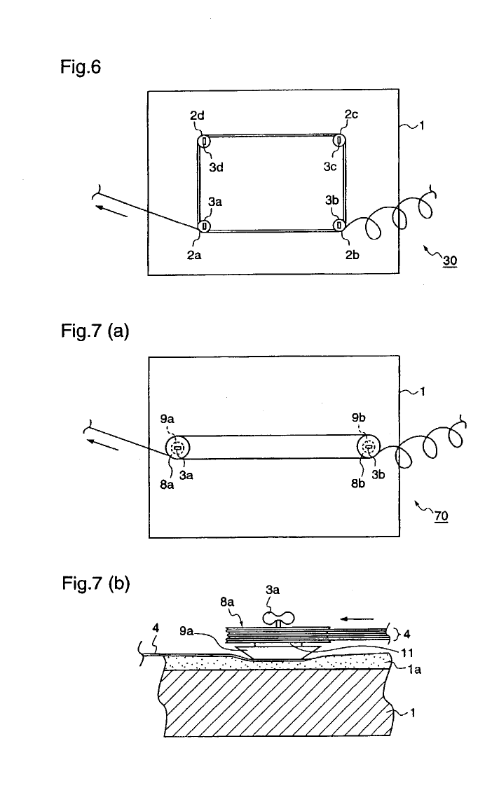

Next, a fishing line straightening device according to a third embodiment of the present invention will be described. FIG. 6 is a plane view for explaining a fishing line straightening device 30 according to the third embodiment. In FIG. 6, the same reference numerals as those shown in FIG. 1 denote the same or corresponding parts.

The fishing line straightening device 30 according to the third embodiment is provided with line pressing members 2c and 2d for fixing a fishing line 4 on the surface of a worktable 1, in addition to the components of the fishing line straightening device 10 according to the first embodiment. The line pressing members 2c and 2d are fixed on the surface of the worktable 1 by wing nuts 3c and 3d, respectively. In this fishing line straightening device 30, the line pressing members 2a, 2b, 2c, and 2d are arranged so that they are positioned at the apexes of a prescribed rectangle.

Next, a description will be given of how to use the fishing line straightening device 30. Initially, a required length of fishing line 4 is fixed on the surface of the worktable 1 by the four line pressing members 2a, 2b, 2c, and 2d so that it is wound around the rectangle many times.

Then, the fishing line 4 between the adjacent line pressing members is heated using a heated iron member such as a home-use iron, while blowing steam onto the fishing line 4. When this first heat treatment is finished, the fishing line 4 is moved so that the portions of the fishing line 4 which are placed under the respective line pressing members 2a, 2b, 2c, and 2d and thus not subjected to the heat treatment, are located between the adjacent line pressing members.

Thereafter, the portions of the fishing line 4 which were positioned under the line pressing members 2a, 2b, 2c, and 2d and not subjected to the first heat treatment, are heated in the same way as described above using the iron or the like, while blowing steam thereto. When this second heat treatment is finished, the fishing line 4 fixed by the line pressing members 2a, 2b, 2c, and 2d is detached, whereby a required length of straightened fishing line 4 is obtained.

As described above, according to the third embodiment, the line pressing members 2a, 2b, 2c, and 2d are attached to the worktable 1 so that they are positioned at the apexes of a prescribed rectangle. Thus, a required length of fishing line 4 can be fixed on the surface of the worktable 1 by the four line pressing members 2a, 2b, 2c, and 2d so that it is wound around the rectangle many times. Therefore, the curl of the desired length of fishing line 4 can be removed with high workability.

While in this third embodiment the four line pressing members are arranged on the worktable 1 so that they are positioned at the apexes of a rectangle, the number of line pressing members to be arranged on the worktable 1 is not restricted to four. Further, the arrangement of the plural line pressing members on the worktable 1 is not restricted to that described for the third embodiment.

[Embodiment 4]

Next, a fishing line straightening device according to a fourth embodiment of the present invention will be described. FIGS. 7(a) and 7(b) are a plane view and a partial cross-sectional view for explaining a fishing line straightening device 70 according to the fourth embodiment, respectively. In these figures, the same reference numerals as those shown in FIG. 1 denote the same or corresponding parts. The fishing line straightening device 70 is provided with pulleys 8a and 8b on line pressing members 9a and 9b fixed onto the surface of the worktable 1, respectively. A fishing line 4 is wound around the pulleys 8a and 8b plural times.

As shown in FIG. 7(b), the line pressing member 9a is different from the line pressing member 2a shown in FIG. 1 in that the line pressing member 9a has a tapered part that comes in contact with the cloth member 1a, thereby to fix the fishing line 4 more easily. Further, the pulley 8a is rotatably mounted on the line pressing member 9a via a washer by a bearing in the center (not shown). The pulley 8a, the washer 11, and the line pressing member 9a are fixed at a prescribed position on the worktable 1 by a wing nut 3a.

Next, a description will be given of how to use the fishing line straightening device 70. Initially, an end of the fishing line 4 is fixed using the line pressing member 9a, a required length of fishing line 4 is wound around the two pulleys 8a and 8b many times, and the other end of the fishing line 4 is fixed using the line pressing member 9b.

Then, the fishing line 4 between the adjacent line pressing members 9a and 9b is heated using a heated iron member such as a home-use iron, while blowing steam to the fishing line 4. When this first heat treatment is finished, the fishing line 4 is moved by rotating the pulleys 8a and 8b so that the portions of the fishing line 4 that are positioned under the respective line pressing members 9a and 9b and thus not subjected to the heat treatment are located between the adjacent line pressing members.

Thereafter, the portions of the fishing line 4 that were positioned under the line pressing members 9a and 9b and not subjected to the first heat treatment are heated in the same way as described above by using the iron or the like, while blowing steam thereto. When this second heat treatment is finished, the fishing line 4 fixed by the line pressing members 9a and 9b is detached, whereby a required length of straightened fishing line 4 is obtained.

As described above, according to the fourth embodiment of the invention, the pulleys 8a and 8b are provided on the line pressing members 9a and 9b, respectively. Thus, an end of the fishing line 4 is fixed on the surface of the worktable 1 by the line pressing member 9a, a required length of fishing line 4 is wound around the pulleys 8a, 8b many times, and the other end of the fishing line 4 is fixed on the surface of the worktable 1 by the line pressing member 9b. Therefore, the curl of the required length of fishing line 4 can be removed with high workability.

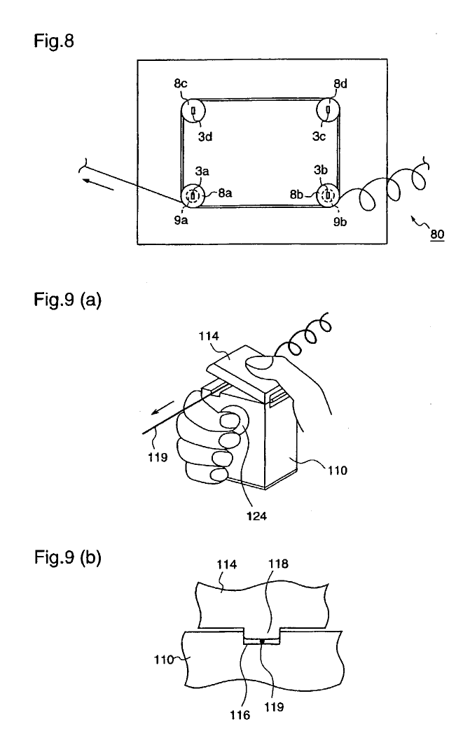

While in this fourth embodiment two pulleys are provided and the fishing line is wound around the pulleys, as shown in FIG. 8, four pulleys 8a˜8d may be arranged on the worktable 1 so that they are positioned at the apexes of a rectangle as described in the third embodiment.

Further, while in the above-described first to fourth embodiments a steam iron or the like is employed as an iron member for heating the fishing line 4 while blowing steam thereto, an apparatus employed as an iron member is not restricted to the steam iron, and any means may be employed as long as it is able to spray steam onto the fishing line 4 and, simultaneously, heat the fishing line 4.

[Embodiment 5]

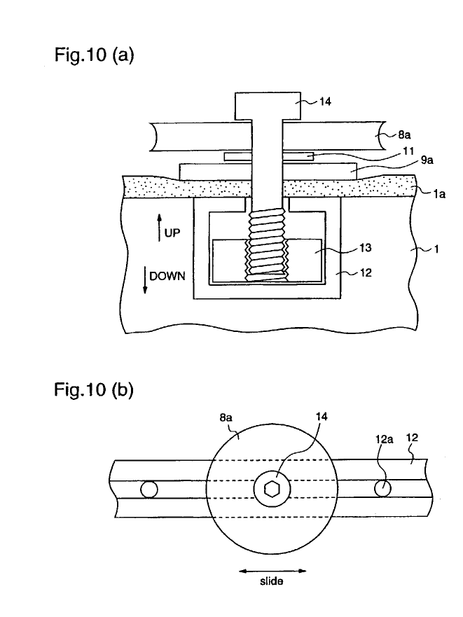

Next, a fishing line straightening device according to a fifth embodiment of the present invention will be described. FIGS. 10(a) and 10(b) are diagrams illustrating the construction of a line pressing member of a fishing line straightening device according to the fifth embodiment. In these figures, the same reference numerals as those shown in FIG. 7 denote the same or corresponding parts. Reference numeral 12 denotes a rail member having a substantially U-shaped cross section, which is made of a material such as aluminum or stainless steel, and the rail member 12 is actually buried in the worktable 1. As shown in FIG. 10(b), openings 12a are appropriately provided at the bottom surface of the rail member 12. During spraying of steam, the steam escapes through the openings 12a to the worktable 1, thereby preventing water from pooling in a groove of the rail member 12.

Further, a rectangle nut 13 which is shaped such that at least two sides thereof contact the side walls of the groove, is arranged in the groove of the rail member 12. A pulley 8a, a washer 11, and a line pressing member 9a are axially supported by, for example, a hexagon bolt screw 14 which is screwed to the nut 13. By fastening or loosening this bolt 14, the positions of the pulley 8a and the line pressing member 9a can be fixed with respect to the rail member 12.

Next, the operation will be described. A fishing line is wound around the so-constructed pulleys 8a and 8b plural times, and the pulley 8a is slid in the direction along which the pulley 8a gets away from the pulley 8b to stretch the fishing line and, in this state, the bolt 14 is rotated in the direction along which the bolt 14 is fastened. Then, the nut 13 is moved upward (in the UP direction) in the groove of the rail member 12 in accordance with the rotation of the bolt 14, and the upper surface of the nut 13 contacts the upper surface of the rail member 12, thereby to fix the pulley 8a, the washer 11 and the line pressing member 9a with respect to the rail member 12.

Thereafter, the fishing line is subjected to steam heating to straighten the curl thereof as described for the fourth embodiment, and thereafter, the bolt 14 is rotated in the direction along which it is loosened so that the pulley 8a, the washer 11, and the line pressing member 9a are free from being fixed with respect to the rail member 9a. Then, the pulley 8a is slid in the direction along which the pulley 8a gets closer to the pulley 8b, and the fishing line stretched between the pulleys 8a and 8b is detached from the pulleys.

As described above, according to the fifth embodiment of the invention, the pulley 8a is movably attached to the rail member 12, and the pulley 8a is fixed in the state where the fishing line is stretched. Then, the fishing line is subjected to steam heating, and thereafter, the pulley 8a is moved again to loosen the stretched fishing line. Therefore, the process of detaching/attaching the fishing line is facilitated, resulting in an increase in work efficiency.

1. A fishing line straightening device comprising a fishing line fixing table for fixing a fishing line, wherein:
said fishing line fixing table has plural fishing line fixing members arranged in at least two positions on its surface, for fixing at least two portions of the fishing line so that the fishing line is stretched straight on the fixing table, and
serves as a worktable when the fishing line fixed on the surface of the fishing line fixing table is subjected to a process of pressing the fishing line using a heated iron member while blowing stream onto the fishing line.

2. The fishing line straightening device of claim 1, including:
a first bobbin fitting part for rotatably supporting a fishing line bobbin on which the fishing line before being subjected to the pressing process using the iron member is wound, and a second bobbin fitting part for rotatably supporting a winding bobbin for winding the fishing line after being subjected to the pressing process using the iron member, said first and second bobbin fitting parts being placed in the vicinity of the fishing line fixing members.

3. The fishing line straightening device of claim 1, wherein:
said fishing line fixing table has a cloth member covering the surface thereof, and said plural fishing line fixing members are fixed on the cloth member.

4. A fishing line straightening device comprising a fishing line fixing table for fixing a fishing line, wherein:
said fishing line fixing table has
fishing line fixing members on its surface, for fixing two portions of the fishing line having a prescribed length on the surface of the fixing table, and
plural pulley members arranged in at least two positions on the surface of the fixing table, for winding and holding the fishing line at plural points so that the fishing line fixed between the fishing line fixing members is stretched straight, and
serves as a worktable when the fishing line fixed on the surface of the fishing line fixing table is subjected to a process of pressing the fishing line using a heated iron member while blowing stream onto the fishing line.

5. A fishing line straightening method employing a fishing line fixing table for fixing a fishing line, comprising the steps of:
fixing the fishing line by fishing line fixing members arranged in at least two positions on the fishing line fixing table having a flat surface so that the fishing line is stretched straight on a cloth member on the surface of the fixing table, and
blowing steam onto the fishing line fixed on the cloth member on the surface of the fishing line fixing table and, simultaneously, pressing the fishing line using a heated iron member.

6. A fishing line straightening method employing a fishing line fixing table for fixing a fishing line, comprising the steps of:
fixing the fishing line having a prescribed length by fishing line fixing members arranged in two positions on the fishing line fixing table having a flat surface, and winding and holding the fixed fishing line by pulley members arranged in at least two positions on the fixing table so that the fishing line is stretched straight on the fishing line fixing table; and
blowing steam onto the fishing line fixed on the surface of the fishing line fixing table and, simultaneously, pressing the fishing line using a heated iron member.

7. The fishing line straightening device of claim 1, wherein said fishing line fixing members are provided with means for moving the fixing members in the direction along which the fishing line is fixed and stretched as well as in the direction along which the tension of the stretched fishing line is released.
